(19) United States
(12) Patent Application Publication
(10) Pub. No.: US 2024/0354003 A1
(43) Pub. Date: Oct. 24, 2024

(54) ON-THE-FLY PADDING FOR CNN FEATURE MAPS

(71) Applicant: TEXAS INSTRUMENTS INCORPORATED, Dallas, TX (US)

(72) Inventors: Asheesh Bhardwaj, Allen, TX (US); William Leven, Dallas, TX (US); Varun Tripathi, Gurgaon (IN)

(21) Appl. No.: 18/305,871

(22) Filed: Apr. 24, 2023

(51) Int. Cl. G06F 3/06; G06N 3/0464

(52) U.S. Cl. CPC G06F 3/0608; G06F 3/0646; G06F 3/0673; G06N 3/0464

(57) ABSTRACT

Disclosed herein are systems and methods for providing on-the-fly padding to feature maps of convolutional neural networks (CNNs). In an implementation, a processor first identifies a padding schema for a feature map based on a type of convolution to be performed on the feature map. Next the processor identifies a feature vector from the feature map currently in an associated memory. Then, the processor determines a padding for the feature vector based on the padding schema. Finally, the processor applies the padding to the feature vector while the feature vector is transferred from the associated memory to registers of the suitable computer.

### TECHNICAL FIELD

Aspects of the disclosure are related to the field of machine learning and, in particular, to providing on-the-fly padding for convolutional neural networks (CNNs).

### BACKGROUND

Convolutional neural networks (CNNs) serve as a type of machine learning commonly utilized in the field of image processing to perform convolutions for tasks related to classification, object detection, or image segmentation. Typically, inputs to a CNN include images represented as a matrix. Matrices of a CNN, herein referred to as feature maps, store image data corresponding to individual pixels of an entire image. For example, feature maps may store the red-green-blue (RGB) values representative of each pixel in an image.

To ensure the output of a CNN is the same size as the input image, an additional amount of padding is required at the edge of the input feature map to account for the downsizing of data that occurs when performing a convolution. Typically, the required padding of a feature map is added prior to execution of the CNN. As a result, the input to the CNN includes a padded feature map, such that the amount of padding surrounding the feature map satisfies the number of convolutional layers within the CNN, and further satisfies the type of convolution to be performed.

Consequently, current methods to apply padding to the feature maps of a CNN are memory extensive due to the amount of space that is needed by each layer of the CNN to store padded data. For example, certain layers of the CNN exist which do not require padding, but still allocate space in memory to store padded data. As a result, memory resources of layers that do not require padding are wasted to store padding for the following layers of the CNN that do require padding.

### TECHNICAL OVERVIEW

A computer-implemented method for providing on-the-fly padding for feature maps of a convolutional neural network (CNN) is disclosed herein. In an implementation, processing circuitry of a suitable computer identifies a padding schema for a feature map. Next, the processing circuitry identifies a feature vector from the feature map currently in an associated memory. Then, the processing circuitry determines a padding for the feature vector based on the padding schema. Finally, the processing circuitry applies the padding to the feature vector while the feature vector is transferred from the associated memory to registers of the suitable computer.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modification's, and equivalents.

FIG. 1 illustrates an operational environment for providing on-the-fly padding for convolutional neural networks (CNNs) in an implementation.

FIG. 2 illustrates a padding process for providing on-the-fly padding for CNNs in an implementation.

FIG. 3 illustrates a more detailed operational environment for providing on-the-fly padding for CNNs in an implementation.

FIG. 4 illustrates an operational sequence for providing on-the-fly padding for CNNs in an implementation.

FIGS. 5A-5D illustrate a software environment for providing on-the-fly padding for CNNs in an implementation.

FIGS. 6A-6B illustrate another software environment for providing on-the-fly padding for CNNs in an implementation.

FIG. 7 illustrates flowchart for providing on-the-fly padding for CNNs in an implementation.

FIG. 8 illustrates a computing system suitable for implementing the various operational environments, architectures, processes, scenarios, and sequences discussed below with respect to the other Figures.

### DETAILED DESCRIPTION

Systems, methods, and devices are disclosed herein to implement on-the-fly padding for data of convolutional neural networks (CNNs). The disclosed technique(s) may be implemented in the context of hardware, software, firmware, or a combination thereof to provide a method of padding that mitigates the memory allocations while reducing the software complexity of the system. In various implementations, a suitable computing system employs a method to provide on-the-fly padding to the feature maps of a CNN. The method is implemented in program instructions in the context of software stored on and executed by components of the computing system. Although this disclosure describes processes being performed in software, some or all of these processes may be performed by hardware such as processing circuitry, logic circuitry, digital circuitry, and/or analog circuitry.

In an embodiment, processing circuitry described herein identifies a padding schema for a feature map. Feature maps are representative of matrices used to store data for a CNN. For example, feature maps may store image data collected by a camera associated with the CNN. In operation, feature maps are passed through the layers of the CNN to provide data for computations. For certain computations of the CNN, feature maps require a corresponding padding. Padding schemas represent the various padding configurations needed by the CNN to perform accurate computations. More specifically, padding schemas describe dedicated memories storing the various padding handles needed to implement on-the-fly padding. Padding handles describe padding data, specific to certain sections of the feature map, herein referred to as feature vectors. In operation, feature vectors are iteratively streamed to a memory of the processing system to be padded. As such, padding schemas store padding handles representative of the different paddings required to pad the feature vectors of the feature map. In an implementation, padding schemas are determined offline based on the requirements of the CNN and the expected size of the feature vectors.

Upon identifying the appropriate padding schema for the feature map, the processing circuitry identifies a feature vector from the feature map, currently in a memory of the processing system. In an implementation, the memory of the processing system is representative of a level 2 (L2) memory. In an implementation, the L2 memory is representative of an L2 cache of the processing system. In another implementation the L2 memory is representative of an L2 buffer of the processing system. In operation, feature vectors are iteratively streamed from the feature map to the L2 memory. In an implementation, the size of the feature vector is dependent on the available amount of space in the L2 memory. To determine the appropriate padding handle to apply to the feature vector, the processing circuitry identifies the padding requirement of the feature vector based on the padding requirement of the feature vector when represented in the feature map. More specifically, the processing circuitry tracks the position of the streamed feature vectors relative to their position within the corresponding feature map.

In response to identifying the position of the feature vector relative to its position within the corresponding feature map, the processing circuitry determines the appropriate padding handle for the feature vector, based on the padding schema. In an implementation, padding handles of a padding schema are stored in an on-chip memory of the processing unit, such as the level 1 (L1) memory. In an implementation, the L1 memory is representative of an L1 cache of the processing system. In another implementation the L1 memory is representative of an L1 buffer of the processing system. In an implementation, the padding schema stores three types of padding handles including top padding handles, middle padding handles, and bottom padding handles. Top padding handles store paddings for feature vectors containing at least one data element requiring a top pad. For example, a feature vector containing data from an uppermost row of the feature map may be associated with a top padding handle. Middle padding handles store paddings for feature vectors containing one or more data elements requiring left pads and/or right pads. For example, a feature vector containing data from a second or third row of the feature map may be associated with a middle padding handle. Bottom padding handles store paddings for feature vectors containing at least one data element requiring a bottom pad. For example, a feature vector containing data from a lowermost row of the feature map may be associated with a bottom padding handle.

Upon determining the appropriate padding handle for the feature vector, the processing circuitry applies the padding of the padding handle to the feature vector while transferring the feature vector from the L2 memory to registers of the processing system. In an implementation, processing circuitry employs a streaming engine to apply the padding to the feature vector while the transferring the feature vector from the L2 memory to the registers of the processing system. Registers store padded data of the feature map, such that the data may be accessed to perform an operation of the CNN.

The techniques of this disclosure may provide increased flexibility, increased efficiency, and/or reduced complexity. In some examples, these techniques may result in ten times less software complexity and twenty percent fewer data transfers to/from on-chip memory, as compared to other approaches. In addition, the software code to implement these techniques may be twenty percent shorter than the software code for other approaches because of the reduction or elimination of multiple filter dimensions. A lower number of padding handles may result in a performance boost for a respective network layer. The input data can be stored in a smaller memory without padding and without creating multiple copies having different padding configurations. Of course, these advantages are merely examples, and no advantage is required for any particular example.

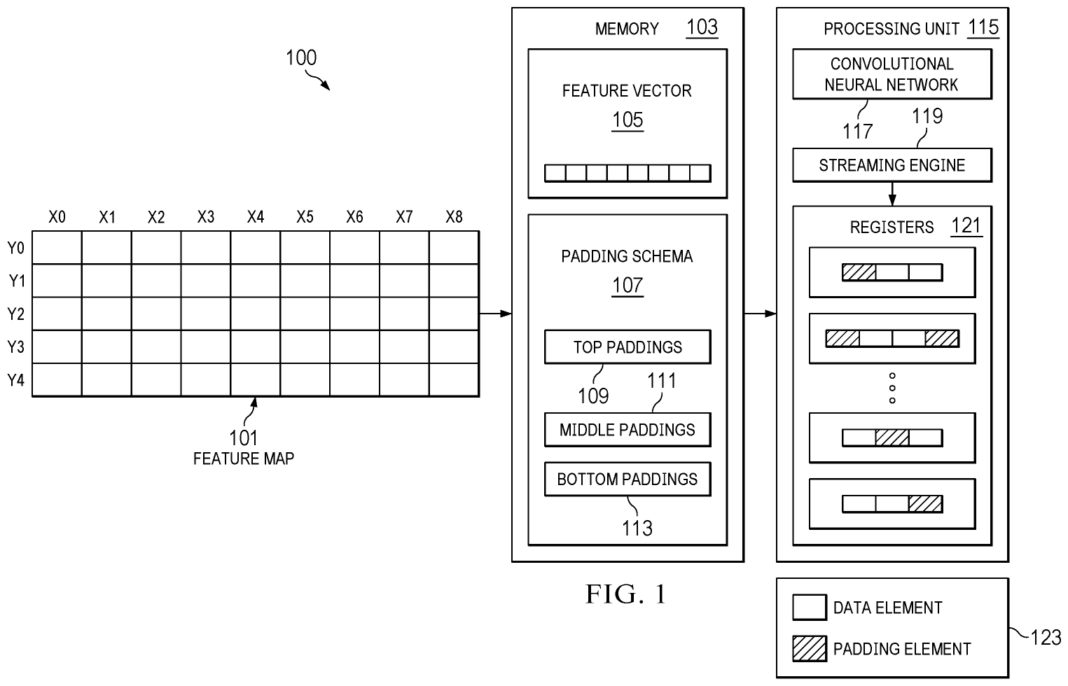

Turning now to the Figures, FIG. 1 illustrates an operational environment for applying on-the-fly padding to CNN feature maps, herein referred to as operational environment 100. Operational environment 100 includes feature map 101, memory 103, and processing unit 115. Operational environment 100 may be implemented in a larger context, such as, for example a vehicle with a vision system, or any other system that may utilize computer vision.

Feature map 101 is representative of a matrix that stores data for a respective CNN. In an implementation, feature map 101 stores data collected by a sensor associated with operational environment 100. For example, feature map 101 may store image data, collected by an associated camera, and represented as a corresponding pixel value such as a pixel's red-green-blue (RGB) value, hex values, hue saturation lightness (HSL) value, or color value of the like. In operation, feature map 101 acts as input to memory 103, to iteratively provide feature vectors which require on-the-fly padding. Feature map 101 may be one of a large number of feature maps. Memory 103 may not have sufficient capacity to store such a large number of feature maps. Thus, smaller tiles of the feature maps may be processed sequentially due to memory constraints. Additional example details of padding for feature vectors can be found in commonly assigned U.S. patent application Ser. No. 18/175,185, entitled “Methods of Batch-Based DNN Processing for Efficient Analytics,” filed on Feb. 27, 2023, and U.S. patent application Ser. No. 17/877,882, entitled “Zero Padding for Convolutional Neural Networks,” filed on Jul. 30, 2022, which is incorporated by reference in its entirety.

Memory 103 is representative of any type of memory such as volatile and nonvolatile, removable and non-removable memory implemented in any method or technology for storage of information, such as computer readable instructions, data structures, program modules, memory, or other data. Examples of memory 103 include random access memory (RAM) such as static RAM (SRAM), read only memory (ROM), programmable ROM, erasable programmable ROM, electronically erasable programmable ROM, solid-state drives, magnetic disks, optical disks, optical media, flash memory, virtual memory and non-virtual memory, magnetic cassettes, magnetic tape, magnetic disk storage or other magnetic storage devices, or any other suitable storage media. In no case is memory 103 a propagated signal.

In an implementation memory 103 is representative of an on-chip memory of processing unit 115. In this case, memory 103 serves as fast access memory for processing unit 115 and is logically coupled to streaming engine 119 to store data required by the system to implement on-the-fly padding of CNN feature maps. As such, memory 103 stores feature vector 105 and padding schema 107. In an implementation, software of processing unit 115 (i.e., CNN 117) directs memory 103 to load the appropriate padding schema for feature map 101 from processing unit 115. Upon determining the appropriate padding schema, software directs memory 103 to iteratively load new feature vectors from feature map 101 to determine an appropriate padding handle to apply to the feature vector from the chosen padding schema.

Feature vector 105 is representative of a section of feature map 101 that has already been loaded into memory 103 (e.g., a kernel buffer of memory 103). In an implementation, sections of feature map 101 are iteratively streamed into memory 103 such that the size of the section (i.e., feature vector 105) is dependent on the available space in memory 103. In another implementation, the size of the section is further dependent on the type of convolutions to be performed. In some examples, feature vector 105 includes one or more rows of feature map 101, where the rows of feature map 101 are arranged in a linear fashion.

Padding schema 107 is representative of a dedicated memory that stores the various padding handles currently required by the system to implement on-the-fly padding. As such, padding schema 107 stores top paddings 109, middle paddings 111, and bottom paddings 113. Each of paddings 109, 111, and 113 may represent tile properties for one or more feature vectors 105. In an implementation, padding schema 107 is loaded from a memory of processing unit 115 to provide the appropriate padding handles for feature map 101. Padding handles of padding schema 107 are representative of the three types of padding data required by feature map 101 to implement on-the-fly padding. Top paddings 109 represent the padding data for sections of feature map 101 that require top padding, left padding, and bottom padding. For example, a feature vector containing data from row Y0 of feature map 101. Middle paddings 111 represent the padding data for sections of feature map 101 that only require left padding and right padding. For example, a feature vector containing data from row Y1 to row Y3 of feature map 101. Bottom paddings 113 represent the padding data for sections of feature map 101 that require left padding, right padding, and bottom padding. For example, a feature vector containing data from Y4 of feature map 101.

Processing unit 115 represents computing hardware, firmware, or a combination thereof that includes processing circuitry capable of executing program instructions to implement the method of on-fly-padding for CNN feature maps. Processing unit 115 includes—but is not limited to—CNN 117, streaming engine 119 and registers 121. Processing unit 115 may be implemented within a single processing device but may also be distributed across multiple processing devices or sub-systems that cooperate in executing program instructions. Examples of processing unit 115 include one or more general purpose central processing units, graphical processing units, microprocessors, digital signal processors, field-programmable gate arrays, application specific processors, processing circuitry, analog circuitry, digital circuitry, and logic devices, as well as any other type of processing device, combinations, or variations thereof. Processing unit 115, CNN 117, and/or streaming engine 119 may be referred to as a kernel.

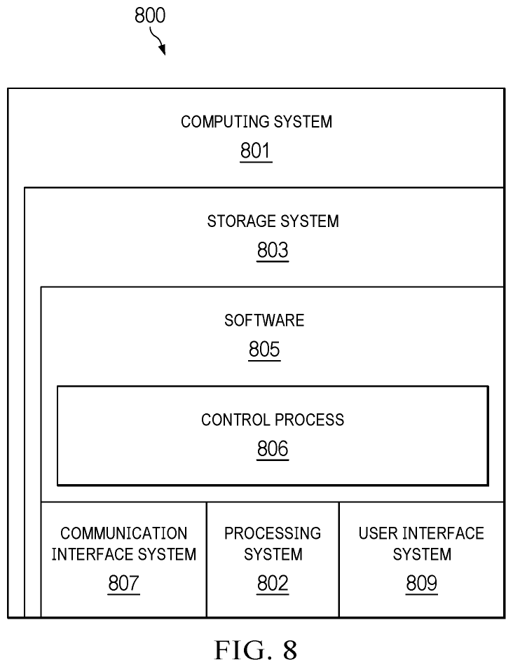

In an implementation processing unit 115 is representative of a vector processor such as Texas Instruments C7X or another processor device capable of vector or array processing. In some implementations, processing unit 115 includes specialized vector or matrix accelerators such as an MMA (matrix multiplication accelerator) for vector/matrix processing, deep learning accelerators, depth and motion accelerators, or video encoding/decoding accelerators. Processing unit 115 includes processors embedded with a parallel processing architecture such as VLIW (Very Long Instructional Word) or (Single Instruction, Multiple Data) SIMD. Processing unit 115 may be implemented on one or more computing devices of which architecture 800 in FIG. 8 is representative.

CNN 117 represents the software employed by processing unit 115 to provide on-the-fly padding while executing the operations of the CNN. In an implementation, CNN 117 instructs the elements of operational environment 100 to perform actions that provide padding to the feature maps of the CNN. For example, CNN 117 communicates with memory 103 and streaming engine 119 to generate padded data required by the CNN. Upon generation, CNN 117 employs software to execute operations of the CNN.

Streaming engine 119 represents computing hardware employed by processing unit 115 to apply padding to data of CNN feature maps. In an implementation, streaming engine 119 receives feature vector 105 and the appropriate padding handle from memory 103. In response, streaming engine 119 pads the data of feature vector 105 based on the appropriate padding handle. Padded data of streaming engine 119 is stored in a register file of processing unit 115 such that the padded data may be used to perform CNN computations.

Registers 121 represent the register file used to store the padded data produced by streaming engine 119. Padded data of registers 121 includes padded portions of feature map 101 such that the padding elements and the data elements are differentiated, as shown by legend 123. In an implementation, CNN 117 collects the required data from registers 121 to perform computations of the CNN.

In operation, processing unit 115 receives feature map 101 for processing by a CNN. In an implementation, feature map 101 stores data collected by an associated sensor. For example, feature map 101 may store image data representative of an image captured by a camera. In another implementation, feature map 101 stores processed data of the CNN which requires on-the-fly padding to continue execution of the CNN.

Upon receiving feature map 101, processing unit 115 employs CNN 117 to determine the appropriate padding schema to load to memory 103. To determine the appropriate padding schema, CNN 117 examines the size of feature map 101, as well as the current requirements of the CNN. For example, if the CNN is about to perform strided convolution, CNN 117 loads a padding schema that accounts for the padding requirements of the strided convolution operation. For strided convolution, the output feature map will have a smaller size than feature map 101. For a stride of two, the output map may be one-fourth of the size of feature map 101. The kernel may be configured to skip one or more rows and one or more columns during strided convolution. Thus, the computation in strided convolution may not be continuous. The approaches described herein include different flows of processing for strided and non-strided convolution.

Upon loading padding schema 107 to memory 103, CNN 117 begins iteratively loading sections of feature map 101 to memory 103. In a first iteration, CNN 117 loads feature vector 105 from feature map 101 to memory 103. In an implementation, the size of feature vector 105 is dependent on the available space in memory 103. In another implementation, the size of feature vector 105 is dependent on current requirements of the CNN.

Next, CNN 117 determines the appropriate padding handle to apply based on the padding requirement of the data within feature vector 105. For example, if feature vector 105 contains data with a top padding requirement, CNN 117 selects a padding handle from top paddings 109. Alternatively, if data within feature vector 105 contains data with a bottom padding requirement, CNN 117 selects a padding handle from bottom paddings 113. Else, CNN 117 selects a padding handle from middle paddings 111.

Upon determining the appropriate padding handle to apply to feature vector 105, CNN 117 instructs memory 103 to transfer feature vector 105 and the corresponding padding handle to streaming engine 119. In response, streaming engine 119 applies the determined padding handle to feature vector 105 to produce a padded feature vector. Output of streaming engine 119 is sent to registers 121 to be stored. In an implementation, feature vectors are iteratively loaded from feature map 101 to memory 103 until the entirety of feature map 101 is represented as padded data, stored within registers 121. Padded data of registers 121 may be accessed by CNN 117 to perform operations such as strided or non-strided convolutions.

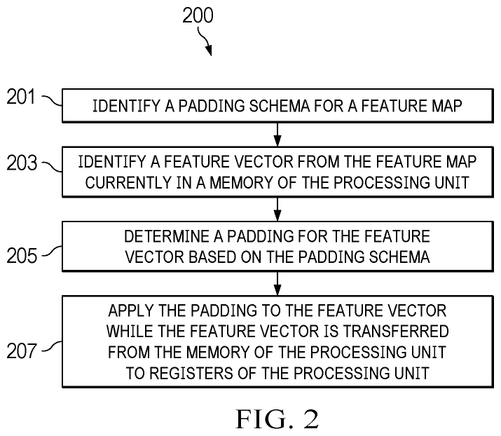

FIG. 2 illustrates a process to provide on-the-fly padding for feature maps of a CNN, herein referred to as padding process 200. Padding process 200 may be implemented in the context of program instructions (e.g., CNN 117) that, when executed by a suitable processing system (e.g., processing unit 115), direct the processing circuitry to operate as follows, referring parenthetically to the steps in FIG. 2.

To begin, the processing system receives a feature map that requires padding to allow processing by a CNN. Upon receiving the feature map, processing circuitry of the processing system identifies a padding schema appropriate for the feature map (step 201). In an implementation, the processing system includes a dedicated memory for storing the padding schemas needed to meet the requirements of the system. In operation, the processing circuitry examines multiple factors to determine the appropriate padding schema to utilize from the dedicated memory. In an implementation, processing circuitry determines the appropriate padding schema based on the requirements of the CNN. Further, processing circuitry examines the size of the received feature map to determine the appropriate padding schema.

Upon determining the appropriate padding schema, the processing circuitry identifies a feature vector from the feature map currently loaded in a memory of the processing system (step 203). In an implementation, the memory of the processing system represents a level 2 memory (L2 memory) of the processing system. The feature vector stored by the L2 memory is representative of a section of the feature map which still requires padding. In operation, feature vectors are iteratively streamed to the L2 memory to determine the appropriate padding to apply from the padding schema. In an implementation, the padding for a feature vector is determined based on the feature vectors position within the feature map. For example, certain data of the feature map requires top padding, left padding, right padding, or bottom padding. As a result, paddings for the feature vector are based on the data's original location in the feature map.

Upon identifying the feature vector's location within the feature map, the processing system determines the padding for the feature vector based on the padding schema (step 205). In an implementation the padding schema stores the various padding handles currently required to pad the feature map. For example, the padding schema stores top padding handles, middle padding handles, and bottom padding handles. Top padding handles store the various padding types for feature vectors that contain data with a top pad requirement. Middle padding handles store the various padding types for feature vectors that contain data with a left pad or a right pad requirement. Bottom padding handles store the various padding types for feature vectors that contain data with a bottom pad requirement.

Upon determining the appropriate padding handle to select from the padding schema, the processing circuitry applies the padding to the feature vector while the feature vector is transferred from the L2 memory to the registers of the processing system (step 207). In an implementation, the processing system includes a streaming unit configured to transfer the feature vector from the L2 memory to the registers. The streaming unit is comprised of hardware, configured to insert padding data to the feature vector. In operation, the processing circuitry instructs the streaming unit to apply the padding handle to the feature vector while transferring the feature vector from the L2 memory to the registers of the processing unit.

Padding process 200 is repeated for every feature vector of the feature map. As a result, registers of the processing unit store padded data, representative of a padded feature map. In operation, processing circuitry transmits the padded data of the registers to the CNN to perform an operation. For example, the CNN may perform a convolution of the padded data.

Referring back to FIG. 1, the following describes a brief example of padding process 200 applied in the context of operational environment 100. In operation, processing unit 115 receives feature map 101 for processing by CNN 117. Prior to execution of the CNN, CNN 117 instructs processing unit 115 to apply on-the-fly padding to the received feature map. In a first operation CNN 117 determines the appropriate padding schema for feature map 101. In an implementation CNN 117 selects the appropriate padding schema from a memory of processing unit 115 such that the memory stores the padding schemas required by the CNN. Next, CNN 117 identifies the location of feature vector 105 within feature map 101 to determine the appropriate padding handle to apply to feature vector 105 from padding schema 107. For example, if feature vector 105 contains data from row Y0 of feature map 101, CNN 117 selects padding data from top paddings 109. Alternatively, if feature vector 105 contains data from row Y4 of feature map 101, CNN 117 selects padding data from bottom paddings 113. Else, CNN 117 selects padding data from middle paddings 111.

Upon determining the appropriate padding data to apply to feature vector 105, CNN 117 directs memory 103 to transfer the required data to streaming engine 119 to pad feature vector 105. As a result, streaming engine 119 outputs the padded feature vector to registers 121 to be stored. Registers 121 store padded data of feature vector 105 for access by CNN 117. After the entirety of feature map 101 is represented as padded data within registers 121, CNN 117 transfers the data to the CNN to perform an operation.

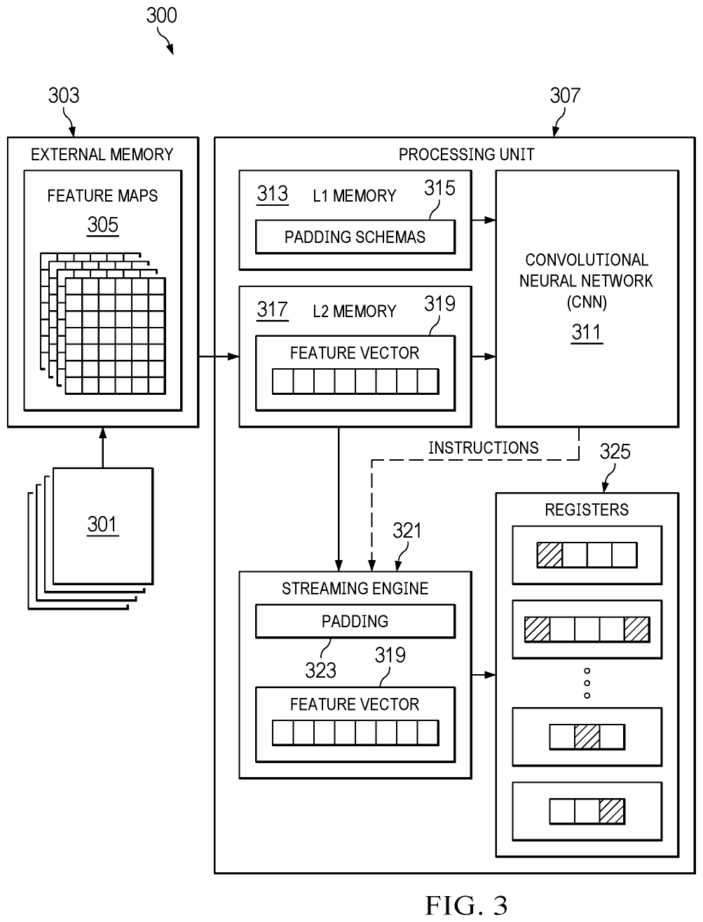

Turning now to the next figure, FIG. 3 illustrates a more detailed operational environment for providing on-the-fly padding to CNN feature maps, herein referred to as operational environment 300. Operational environment 300 is representative of a CNN used in the context of image processing to perform a task such as image classification, object detection, or image segmentation. Operational environment 300 includes images 301, external memory 303, and processing unit 307. Operational environment 300 may be implemented in a larger context, such as, any system that utilizes computer vision.

Images 301 are representative of the multiple images collected by one or more cameras associated with operational environment 300. In an implementation, a camera associated with operational environment 300 may be continuously collecting images for a CNN to a perform task. For example, a camera employed by a vehicular vision system to collect images to detect objects. In another implementation, operational environment 300 employs multiple cameras such that images 301 are representative of the multiple images captured by the multiple cameras.

External memory 303 is representative of any type of memory such as volatile and nonvolatile, removable and non-removable memory implemented in any method or technology for storage of information, such as computer readable instructions, data structures, program modules, memory, or other data. Examples of memory 103 include RAM, ROM, programmable ROM, erasable programmable ROM, electronically erasable programmable ROM, solid-state drives, magnetic disks, optical disks, optical media, flash memory, virtual memory and non-virtual memory, magnetic cassettes, magnetic tape, magnetic disk storage or other magnetic storage devices, or any other suitable storage media. In no case is memory 103 a propagated signal.

In an implementation external memory 303 is representative of a double data rate (DDR) synchronous dynamic RAM (SDRAM), herein referred to as DDR memory. DDR memory describes a type of memory that reads data on both the rising and falling edge of the clock cycle. By reading data in such a manor, DDR memory is able to achieve a faster data rate. In an implementation operational environment 100 implements DDR memory (i.e., external memory 303) to store feature maps 305.

Feature maps 305 are representative of the inputs to the CNN which require on-the-fly padding. Feature maps 305 describe matrices that store image data to be processed by the CNN. In an implementation, feature maps 305 store image data corresponding to images 301. For example, feature maps 305 may store the values representative of the individual pixels of images 301. In another implementation, feature maps 305 store pre-processed data of the CNN which requires on-the-fly padding to continue execution of the CNN. Image data of feature maps 305 may be represented as a pixel's RGB value, hex values, HSL value, or color value of the like. In operation, feature maps 305 acts as input to L2 memory 317, to iteratively stream feature vectors which require on-the-fly padding.

Processing unit 307 represents computing hardware, firmware, or a combination thereof that includes processing circuitry capable of executing program instructions (i.e., CNN 311) to provide on-fly-padding for CNN feature maps. Processing unit 307 includes—but is not limited to—CNN 311, L1 memory 313, L2 memory 317, streaming engine 321, and registers 325. Processing unit 307 may be implemented within a single processing device but may also be distributed across multiple processing devices or sub-systems that cooperate in executing program instructions. Examples of processing unit 307 include one or more general purpose central processing units, graphical processing units, microprocessors, digital signal processors, field-programmable gate arrays, application specific processors, processing circuitry, analog circuitry, digital circuitry, and logic devices, as well as any other type of processing device, combinations, or variations thereof.

In an implementation processing unit 307 is representative of a vector processor such as Texas Instruments C7X or other processor device capable of vector or array processing. In some implementations, processing unit 307 includes specialized vector or matrix accelerators such as an MMA for vector/matrix processing, deep learning accelerators, depth and motion accelerators, or video encoding/decoding accelerators. Processing unit 307 includes processors embedded with a parallel processing architecture such as VLIW or SIMD. Processing unit 307 may be implemented on one or more computing devices of which architecture 800 in FIG. 8 is representative.

CNN 311 represents the software employed by processing unit 307 to perform operations of the CNN. In an implementation, CNN 311 provides instructions to the elements of operational environment 300 to implement the method of on-the-fly padding. For example, CNN 311 may communicate with L1 memory 313 and L2 memory 317 to provide data to streaming engine 321. As a result, streaming engine 321 outputs padded data, ready to be accessed by the CNN. In another implementation, CNN 311 simultaneously performs the computations of the CNN. For example, CNN 311 may execute computations of the CNN in software. Further, CNN 311 may provide instructions to hardware elements of processing unit 307 such as an MMA configured to perform convolutions.

L1 memory 313 represents the level 1 memory of processing unit 307. In an implementation, L1 memory 313 stores padding schemas 315, representative of the multiple padding schemas required by the CNN to perform a task. Different layers of the CNN may perform different operations, such that the different operations require a corresponding padding arrangement. Further, external memory 303 may store data from multiple sources, such that the multiple sources provide feature maps of different sizes. As a result, padding schemas 315 stores the multiple padding schemas needed for the different feature maps received and the different convolutions performed by the CNN.

Individual schemas of padding schemas 315 are representative of dedicated memories used to store the various padding handles required by CNN 311 to implement on-the-fly padding. Padding handles of a padding schema describe the different paddings that may be applied to a feature vector. In an implementation, padding schemas store top padding handles, middle padding handles, and bottom padding handles. Top padding handles are representative of paddings for feature vectors containing data needing a top pad, left pad, and right pad. Middle padding handles are representative of paddings for feature vectors containing data needing a left pad and right pad. Bottom padding handles are representative of padding for feature vectors containing data needing a left pad, right pad, and bottom pad. To determine the appropriate padding handle to apply, CNN 311 examines the feature vector's relative position within the associated feature map to identify the padding requirement of the individual data elements stored within the feature vector.

L2 memory 317 represents the level 2 memory of processing unit 307. L2 memory 317 stores feature vector 319, representative of data that requires on-the-fly padding. In an implementation, sections of a feature map are iteratively streamed from external memory 303 to L2 memory 317 such that the size of the section (i.e., feature vector 319) is determined by CNN 311. In operation, CNN 311 examines the available space in L2 memory 317 as well as the type of computation to be performed by the CNN to determine the size of feature vector 319.

Streaming engine 321 is representative of hardware employed by processing unit 307 to apply padding to the feature vectors stored by L2 memory 317. In an implementation, CNN 311 instructs streaming engine 321 to implement on-the-fly padding. In operation, streaming engine 321 receives feature vector 319 and padding 323 from a respective memory. In response, CNN 311 sends instructions to streaming engine 321 to apply padding 323 to the data of feature vector 319. Streaming engine 321 outputs padded data to registers 325 such that the data may be used to perform computations of the CNN.

Registers 325 represent the register file used to store padded data produced by streaming engine 321. In operation, streaming engine 321 iteratively outputs padded data to registers 325. CNN 311 collects padded data from registers 325 to perform computations of the CNN. For example, CNN 311 may perform a convolution on the padded data.

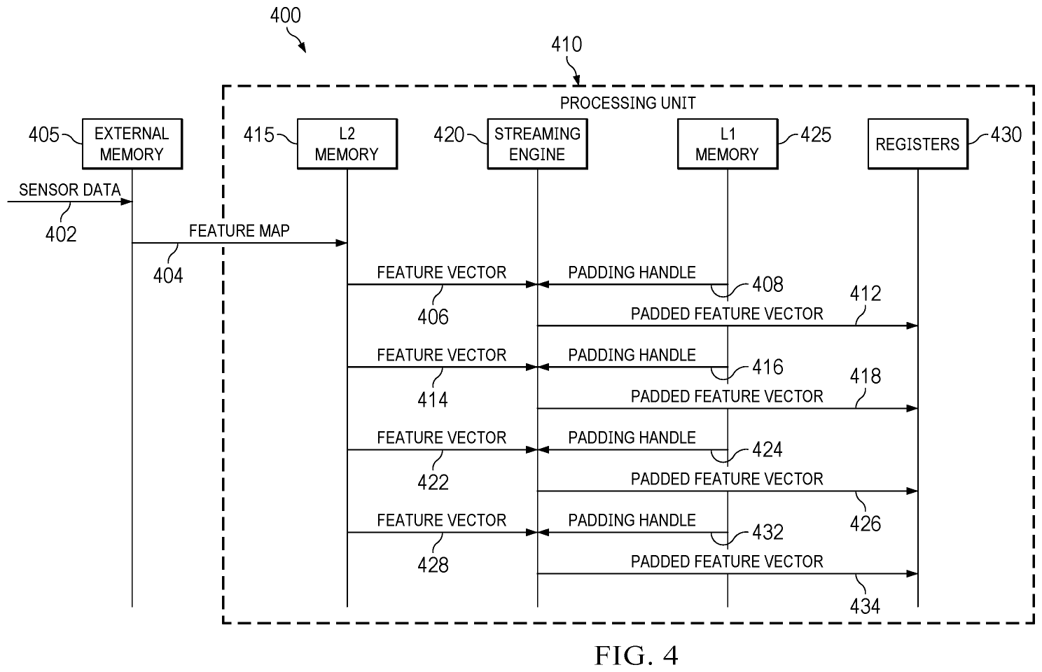

FIG. 4 illustrates an operational sequence for providing on-the-fly padding to feature maps of a CNN, herein referred to as operational sequence 400. Operational sequence 400 includes external memory 405 and processing unit 410. Operational sequence 400 demonstrates how the components of a processing system (e.g., processing unit 307) implement on-the-fly padding.

In operational sequence 400, processing unit 410 includes processing circuitry capable of executing program instructions (e.g., CNN 311) to perform operations of a CNN. Processing unit 115 includes—but is not limited to—L2 memory 415, streaming engine 420, L1 memory 425, and registers 430. In a first operation, external memory 405 receives sensor data 402 in the form of matrix. Sensor data 402 may be representative of image data, audio data, or data of the like collected by a sensor associated with processing unit 410. In an implementation, sensor data 402 is representative of data collected by multiple sensors associated with processing unit 410.

External memory 405 is representative of a memory, coupled with processing unit 410, for storing feature maps which require padding to be processed by a CNN. Feature maps of external memory 405 store sensor data 402. In an implementation sensor data 402 is represented as a singular feature map. In another implementation sensor data 402 is represented as multiple feature maps.

When required by the executing CNN, external memory 405 streams data of the selected feature map to processing unit 410. In an implementation, external memory 405 streams feature map 404 to L2 memory 415. L2 memory 415 is representative of the level 2 memory of processing unit 410. L2 memory 415 iteratively stores sections of feature map 404 such that the size of the section is determined based on the available space in L2 memory 415 and the computation to be performed by the CNN. In an implementation, external memory 405 numerically streams elements of feature map 404 to L2 memory 415 such that the first element received by L2 memory 415 represents the first element of feature map 404.

Upon receiving data of feature map 404, processing unit 410 determines the appropriate padding schema to apply to the data of feature map 404. Padding schemas of a CNN are representative of dedicated memories, used to store padding handles that allow processing unit 410 to iteratively pad sections of a feature map. Padding schemas required by a CNN are determined offline and are stored by processing unit 410. In an implementation, padding schemas required by the CNN are stored by the level 1 memory of processing unit 410, L1 memory 425. In another implementation, padding schemas required by the CNN are stored in an on-chip memory of processing unit 410, such that processing unit 410 executes program instructions to determine the appropriate padding schema to supply to L1 memory 425.

Next, program instructions of processing unit 410 begin iteratively loading the required data to streaming engine 420 to begin operation. Streaming engine 420 represents the computing hardware of processing unit 410 that applies padding to the feature vectors of the associated feature map. In a first iteration, L2 memory 415 loads feature vector 406 to streaming engine 420. Simultaneously L1 memory 425 loads padding handle 408 to steaming engine 420. As a result, streaming engine 420 generates padded feature vector 412. Streaming engine 420 outputs padded feature vector 412 to registers 430 to be stored. In an implementation, padded feature vector 412 is divided into sections that allow registers 430 to provide storage.

Upon loading padded feature vector 412 to registers 430, processing unit 410 begins the next iteration of padding. In the next iteration, feature vector 414 and padding handle 416 are loaded to streaming engine 420. As a result, streaming engine 420 outputs padded feature vector 418 to registers 430. Streaming engine 420 continues to execute padding iterations such that feature vector 422 and padding handle 424 form padded feature vector 426, and feature vector 428 and padding handle 432 form padded feature vector 434.

In an implementation, feature vectors of an associated feature map are iteratively loaded to processing unit 410 to generate padded data representative of a padded feature map. Registers 430 store data representative of the padded feature map such that the data may be accessed by software (i.e., CNN 311) to execute computations of the CNN.

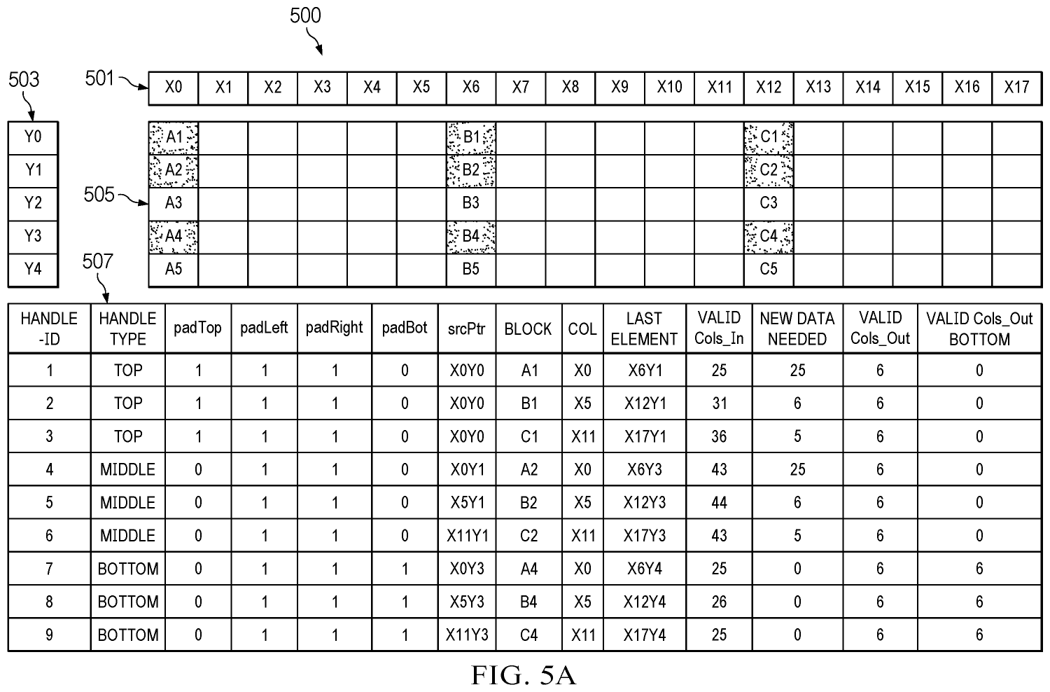

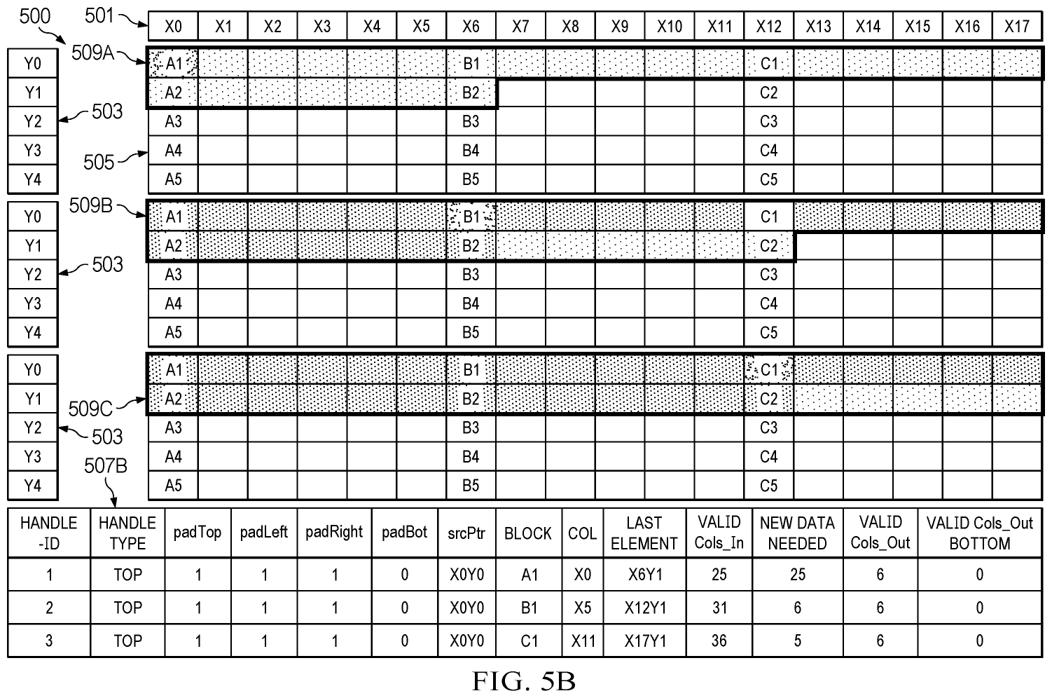

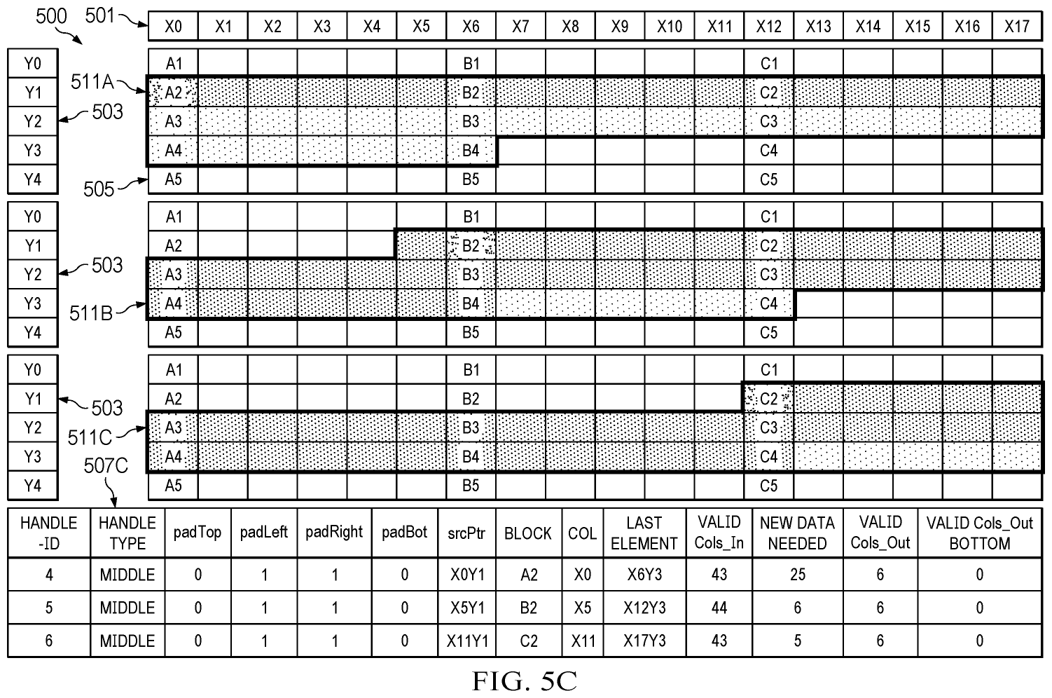

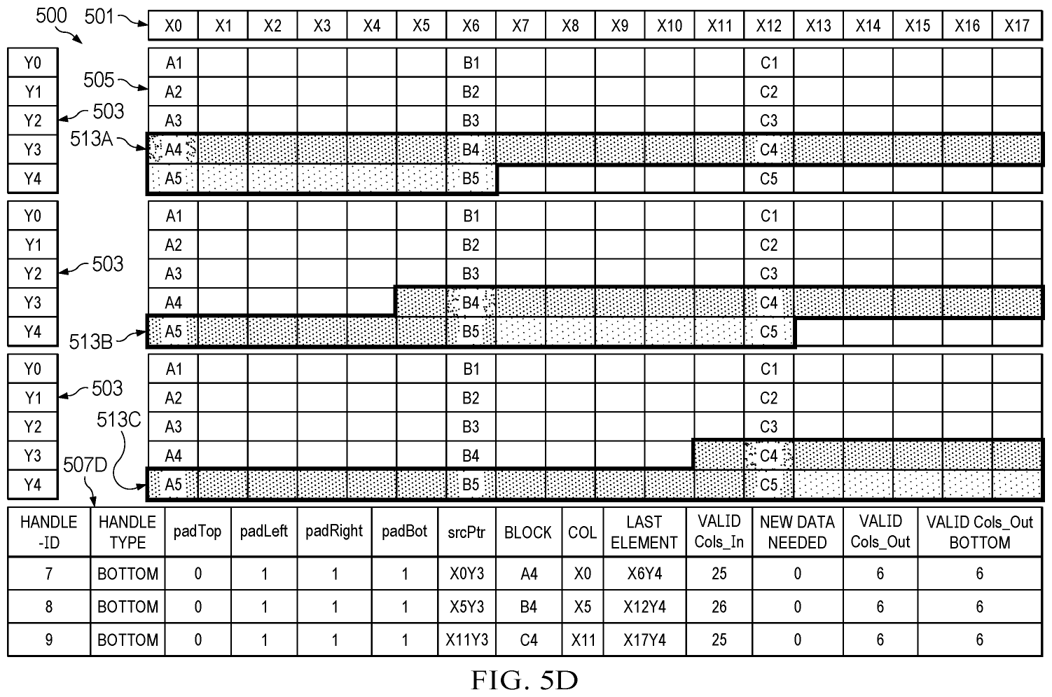

FIGS. 5A-5D illustrates an example software environment for providing on-the-fly padding to CNN feature maps, herein referred to as software environment 500. Software environment 500 is representative of the data elements required by the software to determine the appropriate padding handle for a feature map. Software environment 500 includes X-axis 501, Y-axis 503, feature map 505, and padding schema 507. Software environment 500 may be employed by suitable computing system, in the context of program instructions, executed by processing circuitry of the computing system.

Feature map 505 is representative of an operational input for a layer of the CNN. Typically, feature map 505 stores data values required by the CNN to perform a task. For example, feature map 505 may store pixel values for a task related to image classification or image segmentation. Data stored by feature map 505 may be collected by a sensor, such as a camera associated with the CNN. In an implementation, feature map 505 stores pre-processed data of the CNN which requires on-the-fly padding to continue execution of the CNN. For example, feature map 505 may store the output generated by a layer of the CNN, such that the output requires on-the-fly padding before being supplied as input to a next layer of the CNN.

In an implementation, feature map 505 is represented as a 2D input. For example—as shown in software environment 500—feature map 505 represents an 18×5 matrix such that X-axis 501 corresponds to the columns of feature map 505 and Y-axis 503 corresponds to the rows. In operation, the processing circuitry iteratively streams portions of feature map 505 to a memory of the suitable computing system, such that the portions of feature map 505 are represented as 1D vectors. In other implementations, feature map 505 may be represented as any an n-dimensional input, such that the input may converted to the appropriate 1D representation.

To allow execution of the CNN, data of feature map 505 requires a padding configuration corresponding to the type of operation to be performed by a layer of the CNN. For example, a layer that performs a strided convolution requires a different padding configuration as compared to a layer that performs a non-strided convolution. Previous methods to supply padding would first examine the padding configurations required by each layer within the CNN. Upon determining the padding configurations required by each layer, the processing circuitry applies the total amount padding required by the CNN to the feature map. In an implementation, applying the padding to the feature map describes surrounding the outer edge of the feature map with data elements storing the padding values needed by the CNN to complete an execution. For example, data elements of row Y0 require at least one top pad, while data elements of row Y4 require at least one bottom pad. Alternatively, data elements of column X0 require at least one left pad while data elements of column X17 require at least one right pad. Once generated, the processing circuitry supplies the padded feature map to the CNN to begin execution.

Consequently, previous methods to provide padding to the CNN are memory extensive, as these methods do not account for the layers of the CNN which do not require padding to perform an operation. For example, the input layer of a CNN may not require padding to perform an operation but does require space in memory to store padded data needed by the remaining layers of the CNN. As a result, memory allocations for the layers that do not require padding are wasted. Alternatively, the methods described herein utilize padding handles to supply on-the fly padding to the feature map, such that the data of the feature map is only padded when required. As a result, the layers of the CNN which do not require padding no longer need allocations in memory to store padded values.

Padding schema 507 is representative of a table storing the padding handles required by the CNN to implement on-the-fly padding for a layer performing non-strided convolution. To perform a non-strided convolution with on-the-fly padding, feature map 505 is first converted into a single array and partitioned into vectors suitable for the computing system. More specifically, feature map 505 is partitioned into multiple feature vectors such that the size of the feature vectors is dependent on an available space in memory. Next, processing circuitry determines the appropriate padding handle to apply from padding schema 507. In an implementation, padding schema 507 includes top padding handles, middle padding handles, and bottom padding handles, such that the number of padding handles is dependent on the size of the corresponding feature vectors. Top padding handles represent the padding data for feature vectors containing data with a top pad, left pad, and right pad requirement. For example, feature vectors containing data from row Y0. Middle padding handles represent the padding data for feature vectors containing data with a left pad and right pad requirement. For example, feature vectors containing data from row Y1 to row Y3. Bottom padding handles represent the padding data for feature vectors containing data with a left pad, right pad, and bottom pad requirement. For example, feature vectors containing data from row Y4.

Now turning to FIG. 5B, software environment 500 illustrates a detailed view for providing top padding handles to feature vectors of feature map 505. Software environment 500 includes the same elements as before, altered in a manor to better display the details of the top padding handles. More specifically software environment 500 still includes X-axis 501, Y-axis 503, feature map 505, and padding schema 507B, such that padding schema 507B is representative of the section of padding schema 507 that stores data related to the top padding handles. Further software environment 500 now includes top padding handle 509A, top padding handle 509B, and top padding handle 509C.

In an implementation, feature map 505 requires three top padding handles to supply padding to the data of feature map 505 with a top pad requirement (i.e., data of row Y0). In other implementations, feature map 505 may require more or less top padding handles, such that the amount of top padding handles is dependent on the size of the corresponding feature vectors. Top padding handles of padding schema 507B are representative of the padding data required by row Y0 of feature map 505.

Top padding handle 509A represents the first padding handle employed by the system. Top padding handle 509A corresponds to Handle-ID 1 of padding schema 507B. Data elements required for top padding handle 509A range from X0Y0 to X6Y1 of feature map 505. In an implementation, top padding handle 509A pads data elements from X0Y0 to X5Y0. As a result, when employed by the system, top padding handle 509A produces six valid columns of output representative of padded data from feature map 505.

Top padding handle 509B represents the second padding handle employed by the system. Top padding handle 509B corresponds to Handle-ID 2 of padding schema 507B. Data elements required for top padding handle 509B range from X0Y0 to X12Y1 of feature map 505. In an implementation, top padding handle 509B pads data elements from X6Y0 to X11Y0. As a result, when employed by the system, top padding handle 509B produces six valid columns of output representative of padded data from feature map 505.

Top padding handle 509C represents the third padding handle employed by the system. Top padding handle 509C corresponds to Handle-ID 3 of padding schema 507B. Data elements required for top padding handle 509C range from X0Y0 to X17Y1 of feature map 505. In an implementation, top padding handle 509C pads data elements from X12Y0 to X17Y0. As a result, when employed by the system, top padding handle 509C produces six valid columns of output representative of padded data from feature map 505.

Top padding handles of padding schema 507B are shaded to display the difference between new data and data that has been previously analyzed by a padding handle. For example, shaded portions of top padding handle 509B represent the data previously analyzed by top padding handle 509A. In operation, after employing top padding handles 509A, 509B, and 509C row Y0 of feature map 505 will be represented as padded data, stored in the registers of the suitable computing system.

Now turning to FIG. 5C, software environment 500 illustrates a detailed view for providing middle padding handles to feature vectors requiring left pads and right pads. Software environment 500 includes the same elements as FIG. 5A, altered to better display the details of the middle padding handles. For example, padding schema 507C represents the section of padding schema 507 that stores data related to the middle padding handles. To display the details of middle padding handles, software environment 500 now includes middle padding handle 511A, middle padding handle 511B, and middle padding handle 511C. Shaded portions of the middle padding handles are representative of data that has been previously analyzed.

In an implementation, feature map 505 requires three middle padding handles to supply padding to the data with a left pad and right pad requirement (i.e., data spanning from row Y1 to row Y3). In other implementations, feature map 505 may require more or less middle padding handles, dependent on the size of the corresponding feature vectors. Middle padding handles of padding schema 507C are representative of the padding data required by rows Y1, Y2, and Y3 of feature map 505.

Middle padding handle 511A represents the fourth padding handle employed by the system. Middle padding handle 511A corresponds to Handle-ID 4 of padding schema 507C. Data elements required for middle padding handle 511A range from XOY1 to X6Y3. In an implementation, middle padding handle 511A pads data elements from column X0 to column X5, spanning from row Y1 to row Y3. As a result, when employed by the system, middle padding handle 511A produces six valid columns of output representative of padded data from feature map 505.

Middle padding handle 511B represents the fifth padding handle employed by the system. Middle padding handle 511B corresponds to Handle-ID 5 of padding schema 507C. Data elements required for middle padding handle 511B range from X5Y1 to X12Y3. In an implementation, middle padding handle 511A pads data elements from column X6 to column X11, spanning from row Y1 to row Y3. As a result, when employed by the system, middle padding handle 511B produces six valid columns of output representative of padded data from feature map 505.

Middle padding handle 511C represents the sixth padding handle employed by the system. Middle padding handle 511C corresponds to Handle-ID 6 of padding schema 507C. Data elements required for middle padding handle 511C range from X11Y1 to X17Y3. In an implementation, middle padding handle 511A pads data elements from column X12 to column X17, spanning from row Y1 to row Y3. As a result, when employed by the system, middle padding handle 511C produces six valid columns of output representative of padded data from feature map 505. In operation, after employing middle padding handles 511A, 511B, and 511C rows Y1, Y2, and Y3 of feature map 505 will be represented as padded data, stored in the registers of the suitable computing system.

Now turning to FIG. 5D, software environment 500 illustrates a detailed view for providing bottom padding handles to feature vectors of feature map 505. Software environment 500 includes the same elements as FIG. 5A, altered to better display the details of the bottom padding handles. For example, padding schema 507D represents the section of padding schema 507 that stores data related to the bottom padding handles. To better display the details of the bottom padding handles, software environment 500 also includes bottom padding handle 513A, bottom padding handle 513B, and bottom padding handle 513C. As explained by the previous padding handles, shaded portions of the bottom padding handles are representative of data that has been previously analyzed.

In an implementation, feature map 505 requires three bottom padding handles to supply padding to the data of feature map 505 with a bottom pad requirement (i.e., data of row Y4). In other implementations, feature map 505 may require more or less bottom padding handles, dependent on the size of the corresponding feature vectors. Bottom padding handles of padding schema 507D are representative of the padding data required by row Y4 of feature map 505.

Bottom padding handle 513A represents the seventh padding handle employed by the system. Bottom padding handle 513A corresponds to Handle-ID 7 of padding schema 507D. Data elements required for bottom padding handle 513A range from X0Y3 to X6Y4. In an implementation, bottom padding handle 513A pads data elements from X0Y4 to X5Y4. As a result, when employed by the system, bottom padding handle 513A produces six valid columns of output representative of padded data from feature map 505.

Bottom padding handle 513B represents the eighth padding handle employed by the system. Bottom padding handle 513B corresponds to Handle-ID 8 of padding schema 507D. Data elements required for bottom padding handle 513B range from X5Y3 to X12Y4. In an implementation, bottom padding handle 513B pads data elements from X6Y4 to X11Y4. As a result, when employed by the system, bottom padding handle 513B produces six valid columns of output representative of padded data from feature map 505.

Bottom padding handle 513C represents the ninth, and final padding handle employed by the system. Bottom padding handle 513C corresponds to Handle-ID 9 of padding schema 507D. Data elements required for bottom padding handle 513C range from X11Y3 to X17Y4. In an implementation, bottom padding handle 513C pads data elements from X12Y4 to X17Y4. As a result, when employed by the system, bottom padding handle 513C produces six valid columns of output representative of padded data from feature map 505. In operation, after employing bottom padding handles 513A, 513B, and 513C row Y4 of feature map 505 will be represented as padded data, stored in the registers of the suitable computing system.

Upon applying top padding handles 509A, 509B, 509C, middle padding handles 511A, 511B, 511C, and bottom padding handles 513A, 513B, 513C, the entirety of feature map 505 is represented as padded data in the registers of the suitable computing system. In an implementation, processing circuitry gathers the padded data to perform a non-strided convolution of the CNN.

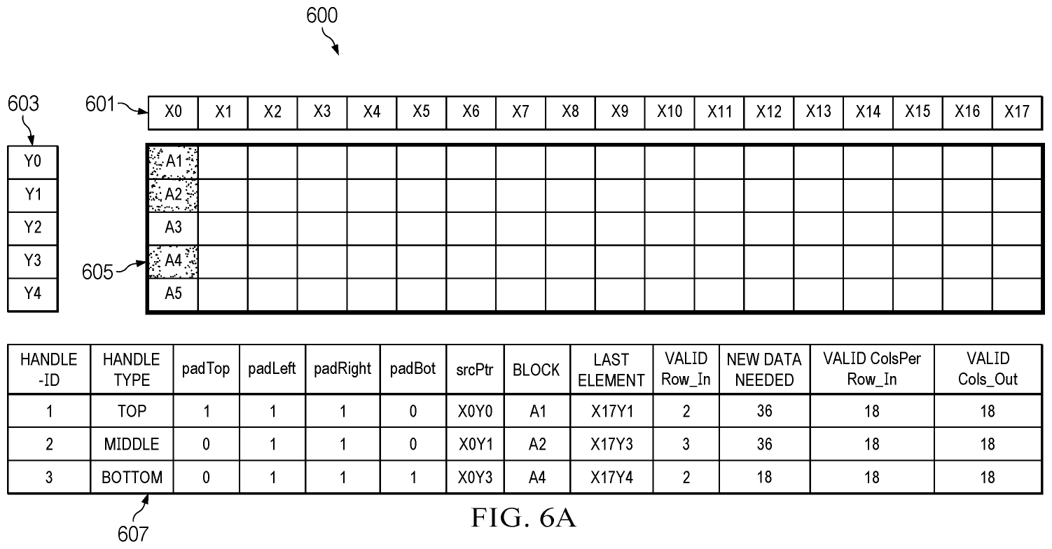

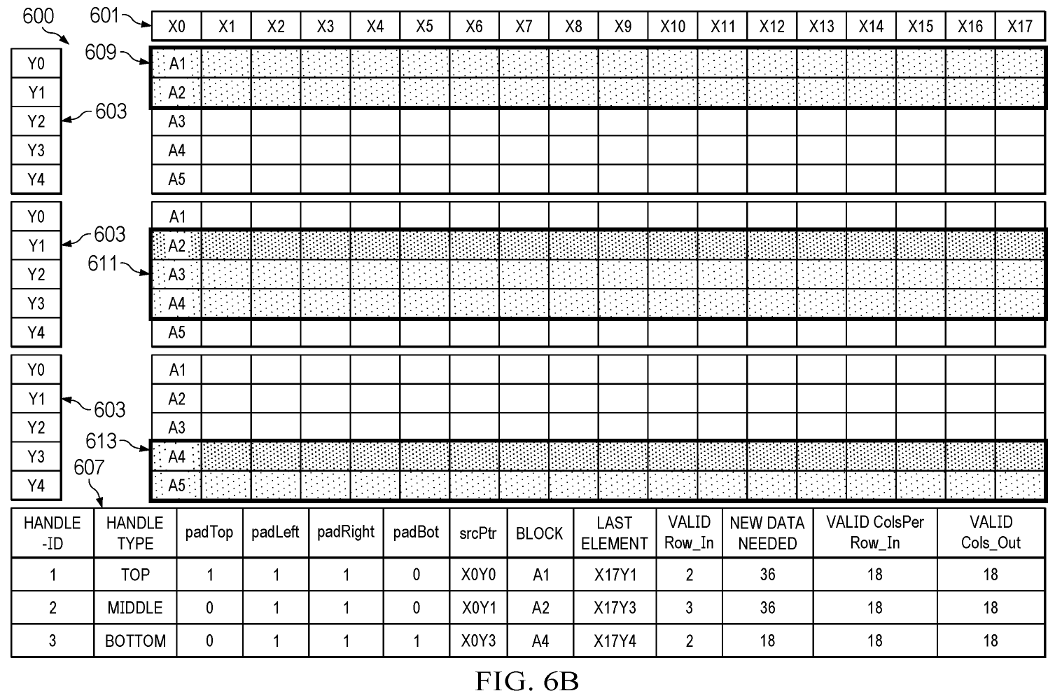

FIGS. 6A-6B illustrates another example software environment for providing on-the-fly padding to CNN feature maps, herein referred to as software environment 600. Software environment 600 is representative of the data elements required by the software to determine the appropriate padding handle for a feature map. Software environment 600 includes X-axis 601, Y-axis 603, feature map 605, and padding schema 607. In an implementation, feature map 605 is representative of feature map 505 of software environment 500. Software environment 600 may be employed by suitable computing system, in the context of program instructions, executed by processing circuitry of the computing system.

Padding schema 607 is representative of a table storing the padding handles required by the CNN to implement on-the-fly padding for a layer performing strided convolution. To perform strided convolution with on-the-fly padding, feature map 605 is first partitioned into vectors, such that each vector corresponds to a row of feature map 605. More explicitly, feature map 605 is partitioned into five vectors such that the first vector stores data of row Y0, the second vector stores data of row Y1, and so on. In an implementation, padding schema 607 includes a top padding handle, middle padding handle, and bottom padding handle. Top padding handle of padding schema 607 represents the padding data for the feature vector containing data from row Y0. Middle padding handle of padding schema 607 represents the padding data for feature vectors containing data from row Y1, Y2, or Y3. Bottom padding handles of padding schema 607 represent the padding data for the feature vector containing data from row Y4.

Now turning to FIG. 6B, software environment 600 illustrates a detailed view for providing the appropriate padding handles for the strided convolution. Software environment 600 includes the same elements as FIG. 6A, altered in a manor to better display the details of the padding handles. Software environment 600 still includes X-axis 601, Y-axis 603, feature map 605, and padding schema 607. Further software environment 600 also includes top padding handle 609, middle padding handle 611, and bottom padding handle 613.

In an implementation, feature map 605 requires three padding handles to provide the appropriate padding for the strided convolution to be performed. In other implementations, feature map 605 may require more or less padding handles, such that the amount of padding handles is dependent on the size of the corresponding feature vectors.

Top padding handle 609 represents the first padding handle employed by the system. Top padding handle 609 corresponds to Handle-ID 1 of padding schema 607. Data elements required for top padding handle 609 range from X0Y0 to X17Y1. In an implementation, top padding handle 609 pads data elements from X0Y0 to X17Y0. As a result, when employed by the system, top padding handle 609 produces 18 valid rows of output, representative of padded data from feature map 605.

Middle padding handle 611 represents the second padding handle employed by the system. Middle padding handle 611 corresponds to Handle-ID 2 of padding schema 607. Data elements required for middle padding handle 611 range from X0Y1 to X17Y3. In an implementation, middle padding handle 611 pads data elements from X0Y1 to X17Y3. As a result, when employed by the system, middle padding handle 611 produces 18 valid rows of output, representative of padded data from feature map 605.

Bottom padding handle 613 represents the third padding handle employed by the system. Bottom padding handle 613 corresponds to Handle-ID 3 of padding schema 607. Data elements required for bottom padding handle 613 range from X0Y3 to X17Y4. In an implementation, bottom padding handle 613 pads data elements from X0Y4 to X17Y4. As a result, when employed by the system, bottom padding handle 613 produces 18 valid rows of output, representative of padded data from feature map 605.

Upon applying top padding handle 609, middle padding handle 611, and bottom padding handle 613 the entirety of feature map 605 is represented as padded data in the registers of the suitable computing system. In an implementation, processing circuitry gathers the padded data to perform a strided convolution of the CNN.

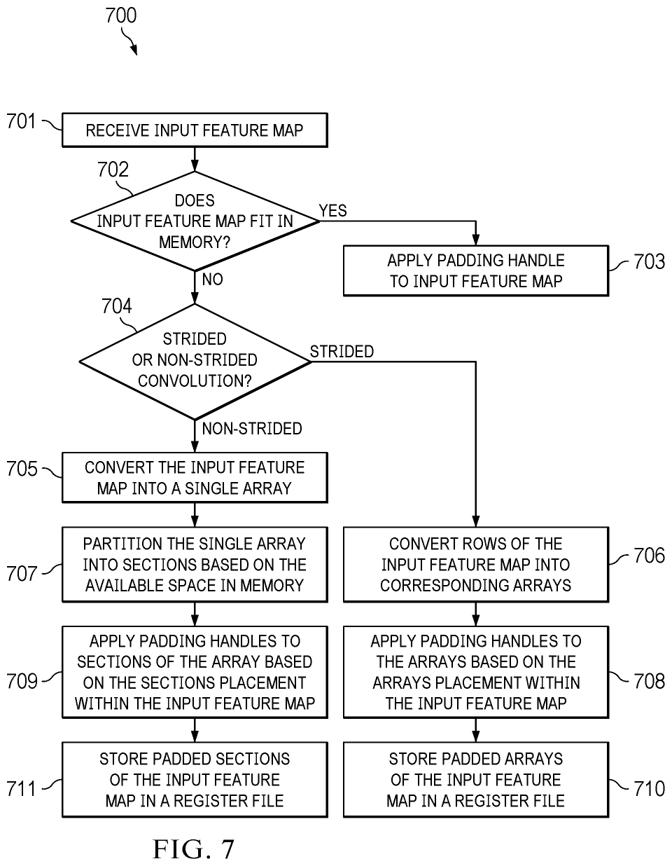

FIG. 7 illustrates a flowchart describing a method to provide on-the-fly padding for feature maps of a CNN, herein referred to as process 700. Process 700 may be implemented in the context of program instructions (e.g., CNN 117 or CNN 311) that, when executed by a suitable processing system (e.g., processing unit 115 or processing unit 307), direct the processing circuitry to operate as follows, referring parenthetically to the steps in FIG. 7.

To begin, the processing circuitry receives an input feature map in need of padding (step 701). The input feature map stores data required by the CNN to perform a task. For example, the feature map may store pixel data representative of an image. In an implementation, the input feature map stores pre-processed data of the CNN requiring on-the-fly padding to allow the CNN to continue execution.

Next, the processing circuitry determines if the entire input feature map fits in the memory of the processing system (step 702). In an implementation, processing circuitry streams data of the input feature map to the L2 memory of the processing system. If the L2 memory is capable of storing all of the data of the input feature map, processing circuitry applies a single padding handle to the input feature map (step 703). Padding handles of such implementations include top pads, left pads, right pads, and bottom pads.

Alternatively, if the input feature map is too large for the capacity of the L2 memory, processing circuitry identifies the type of convolution to be performed by the CNN. If the CNN is about to perform non-strided convolution, the processing circuitry converts the input feature map into a single array (step 705).

Next, the processing circuitry partitions the array into sections based on the available space in the L2 memory (step 707). Sections of the array, herein referred to as feature vectors, are streamed from the array to the L2 memory on a per vector basis. In response to a feature vector being loaded to the L2 memory, the processing circuitry applies a padding handle to the feature vector based on the feature vectors placement within the input feature map (step 709). Padding handles describe padding data that is inserted to the feature vector to allow the CNN to perform the non-strided convolution. Padding data of the padding handle is determined based on the padding requirement of the feature vector data, when represented within the input feature map. Finally, the processing circuitry transmits the padded feature vector to a register file of the processing unit (step 711). Steps 709 and 711 are repeated for every feature vector of the array. As a result, the input feature map is represented as padded data in the registers of the processing system. Processing circuitry may access the padded data of the registers to perform the non-strided convolution.

Alternatively, if the CNN is about to perform strided convolution, the processing circuitry converts the rows of the input feature map into corresponding arrays, herein referred to as feature vectors (step 706). Next, the processing circuitry streams the feature vectors of the input feature map to the L2 memory on a per vector basis. In response to a feature vector being loaded to the L2 memory, the processing circuitry applies a padding handle to the feature vector based on the feature vectors placement within the input feature map (step 708). Finally, the processing circuitry transmits the padded feature vector to a register file of the processing unit (step 710). Steps 708 and 710 are repeated for every feature vector of the input feature map. As a result, the input feature map is represented as padded data in the registers of the processing system. Processing circuitry may access the padded data of the registers to perform the strided convolution.

Turning now to FIG. 8, architecture 800 illustrates computing system 801 that is representative of any system or collection of systems in which the various processes, programs, services, and scenarios disclosed herein may be implemented. Examples of computing system 801 include, but are not limited to, general purpose computers, application specific computers such as automotive computers or aerospace computers, embedded computers, industrial computers, server computers, MCUs, and personal computers. One specific example of a computing platform includes the Jacinto 7 from Texas Instruments.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809 (optional). Processing system 802 is operatively coupled with storage system 803, communication interface system 807, and user interface system 809.

Processing system 802 loads and executes software 805 from storage system 803. Software 805 includes and implements process 806, which is representative of the processes discussed with respect to the preceding Figures, such as padding process 200 or process 700. When executed by processing system 802, software 805 directs processing system 802 to operate as described herein for at least the various processes, operational scenarios, and sequences discussed in the foregoing implementations. Computing system 801 may optionally include additional devices, features, or function not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include one or more general purpose central processing units, graphical processing units, microprocessors, digital signal processors, field-programmable gate arrays, application specific processors, processing circuitry, analog circuitry, digital circuitry, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including process 806) may be implemented in program instructions and among other functions may, when executed by processing system 802, direct processing system 802 to operate as described with respect to the various operational scenarios, sequences, and processes illustrated herein. For example, software 805 may include program instructions for implementing the processes as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing system 801 is representative) overall from a general-purpose computing system into a special-purpose computing system customized to support image processing. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary, etc.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A system comprising:
a processing unit, wherein the processing unit comprises registers;
memory operatively coupled with the processing unit; and
wherein the processing unit is configured to at least:
identify a padding schema for a feature map;
identify a feature vector from the feature map currently in the memory;
determine a padding for the feature vector based on the padding schema; and
apply the padding to the feature vector while the feature vector is transferred from the memory to the registers of the processing unit.

2. The system of claim 1 wherein the feature map comprises multiple feature vectors at different positions within the feature map, and wherein the padding schema defines the padding for the vectors based on a position of each of the multiple feature vectors within the feature map.

3. The system of claim 1 wherein the memory comprises level 2 memory (L2 memory) of the processing unit, and wherein the processing unit is further configured to iteratively transfer the feature map from external memory to the L2 memory on a per-feature vector basis.

4. The system of claim 3 further comprising a streaming unit configured to transfer the feature vector from the L2 memory to the registers of the processing unit.

5. The system of claim 4 wherein, to apply the padding to the feature vector, the processing unit is configured to instruct the streaming unit to apply the padding to the feature vector while transferring the feature vector from the L2 memory to the registers of the processing unit.

6. The system of claim 5 wherein to apply the padding to the feature vector the streaming unit is configured to insert zeros into the feature vector as instructed by the processing unit, resulting in a padded feature vector.

7. The system of claim 6 wherein the processing unit is further configured to execute a deep neural network (DNN) having a convolutional neural network (CNN) layer that takes the padded feature vector as input and produces a convolved feature vector as output.

8. The system of claim 1 wherein, to identify the padding schema, the processing unit is configured to identify a source of the feature map and select a one of a group of padding schemas that corresponds to the source of the feature map.

9. A computing apparatus comprising:
one or more computer-readable storage media;
a processing unit comprising a memory and registers and wherein the processing unit is operatively coupled with the one or more computer-readable storage media; and
program instructions stored on the one or more computer-readable storage media that, when executed by the processing unit, direct the processing unit to at least:
identify a padding schema for a feature map;
identify a feature vector from the feature map currently in the memory;
determine a padding for the feature vector based on the padding schema; and
apply the padding to the feature vector while the feature vector is transferred from the memory to the registers of the processing unit.

10. The computing apparatus of claim 9 wherein the feature map comprises multiple feature vectors at different positions within the feature map, and wherein the padding schema defines the padding for the vectors based on a position of each of the multiple feature vectors within the feature map.

11. The computing apparatus of claim 9 wherein the memory comprises level 2 memory (L2 memory) of the processing unit, and wherein the program instructions further direct the computing apparatus to iteratively transfer the feature map from external memory to the L2 memory on a per-feature vector basis.

12. The computing apparatus of claim 11 further comprising a streaming unit configured to transfer the feature vector from the L2 memory to the registers of the processing unit.

13. The computing apparatus of claim 12 wherein to apply the padding to the feature vector, the program instructions further direct the computing apparatus to instruct the streaming unit to apply the padding to the feature vector while transferring the feature vector from the L2 memory to the registers of the processing unit.

14. The computing apparatus of claim 13 wherein to apply the padding to the feature vector, the program instructions further direct the computing apparatus to instruct the streaming unit to insert zeros into the feature vector, resulting in a padded feature vector.

15. The computing apparatus of claim 14 wherein the program instructions further direct the computing apparatus to execute a deep neural network (DNN) having a convolutional neural network (CNN) layer that takes the padded feature vector as input and produces a convolved feature vector as output.

16. The computing apparatus of claim 9 wherein to identify the padding schema, the program instructions further direct the computing apparatus to identify a source of the feature map and select a one of a group of padding schemas that corresponds to the source of the feature map.

17. A method comprising:
identifying a padding schema for a feature map;
identifying a feature vector from the feature map currently in a memory of a processing unit;
determining a padding for the feature vector based on the padding schema; and
applying the padding to the feature vector while the feature vector is transferred from the memory of the processing unit to registers of the processing unit.

18. The method of claim 17 wherein the feature map comprises multiple feature vectors at different positions within the feature map, and wherein the padding schema defines the padding for the vectors based on a position of each of the multiple feature vectors within the feature map.

19. The method of claim 17 further comprising iteratively transferring the feature map from external memory to the memory of the processing unit on a per-feature vector basis.

20. The method of claim 17 wherein to apply the padding to the feature vector, the method further comprises inserting zeros into the feature vector based on the padding schema.
